(19) United States
(12) Patent Application Publication
(10) Pub. No.: US 2017/0175422 A1
(43) Pub. Date: Jun. 22, 2017

(54) STORAGE CASE WITH LOCKING MECHANISM

(71) Applicant: Samuel C. Medawar, Lansing, MI (US)

(72) Inventor: Samuel C. Medawar, Lansing, MI (US)

(21) Appl. No.: 15/381,958

(22) Filed: Dec. 16, 2016

Related U.S. Application Data
(60) Provisional application No. 62/267,978, filed on Dec. 16, 2015.

(51) Int. Cl. E05B 65/00; E05C 9/00; E05C 9/10; E05C 7/04; E05C 19/12; E05B 15/00; E05B 65/06; E05G 1/04; E05C 3/12; E05C 19/00

(52) U.S. Cl. CPC E05B 65/0003; E05C 3/12; E05C 9/006; E05C 9/10; E05C 19/001; E05C 19/12; E05B 15/0053; E05B 65/0075; E05B 65/06; E05G 1/04; E05C 7/04

(57) ABSTRACT

The present invention provides a locking mechanism for particular use in securing doors of a storage safe. The locking mechanism, generally, includes an elongated band, at least one plate rotatably connected to the elongated band, and at least one rod rotatably connected to the at least one plate. The locking mechanism further includes means for actuating for actuating the locking mechanism, the means for actuating being operable between a locking and an unlocking position for translating the elongated band. A stabilizing member ensures that the at least one rod maintains a substantially horizontal position and engages a receptor on an opposed door of the storage safe, thereby locking the doors when in a closed position.

### CROSS-REFERENCE TO RELATED APPLICATIONS

This application is a completion application which claims the priority benefit of co-pending U.S. Provisional Patent Application Ser. No. 62/267,978, filed Dec. 16, 2015, for “Locking Mechanism,” the entire disclosure of which is hereby incorporated by reference in its entirety, including the drawing.

### BACKGROUND OF THE INVENTION

1. Field of the Invention

The present invention pertains to a locking mechanism. More particularly, the present invention pertains to a security locking mechanism for securing door panels together. Even more particularly, the present invention concerns a locking mechanism for a combined display case and storage safe.

2. Description of Prior Art

Display cases are widely known for use in displaying high-value articles such as jewelry, coins, watches, cameras, and the like. A typical display case has one or more glass windows and, thus, is particularly susceptible to theft when a criminal smashes the glass and removes as many valuable articles as possible before escaping.

Oftentimes, retailers will remove high-value items daily from their display cases at the close of business and relocate the merchandise into more secure storage or vault. This routine transfer of goods between the display case and a security storage vault increases the cost of labor required to relocate display items at the beginning and end of each business day. Other problems may result from having to relocate merchandise including possible wear and tear on the merchandise and display fixtures, in addition to issues regarding inventory and loss control.

An example of an apparatus related to a security display case is disclosed in Sands, EP 0521728A1, for a Security Receptacle. While the reference teaches a safe for concealing valuable items, it fails to teach the specifics of a locking mechanism other than doors fitted with conventional locks and bolts.

Furthermore, in U.S. Pat. Nos. 9,078,531 and 9,512,663, the entire disclosures of which are hereby incorporated by reference in their entirety, there is disclosed a combination display case and storage safe or housing. When the items are not on display, the display case is lowered into the housing for additional security. Oftentimes, access into the housing is required and, therefore, the housing typically includes any number of panels that can be opened to provide such access. Nonetheless, neither patent provides a secure locking mechanism that locks the panels to one another and to the housing, itself.

While each of the devices disclosed above are suitable for the uses and problems they solve, there is an ongoing need for improvements in a locking mechanism being incorporated into such security display cases.

Accordingly, it would be advantageous to provide a security display case which protects merchandise from possible theft without requiring the merchandise to be relocated for safe storage before and after business hours.

It is to this to which the present invention is directed.

### SUMMARY OF THE INVENTION

In a first aspect, the present invention provides a locking mechanism comprising: (a) an elongated band; (b) at least one plate rotatably connected to the elongated band; (c) at least one rod rotatably connected to the at least one plate; (d) means for actuating for actuating the locking mechanism, the means for actuating operable between a locking position and an unlocking position for translating the elongated band; (e) a stabilizing member, the stabilizing member maintaining the at least one rod in a substantially horizontal position; and (f) a receptor, the receptor including at least one receptor opening formed therein for receiving the rod.

In a second aspect, the locking mechanism hereof is deployed in conjunction with a storage safe or housing for a display case, the housing, itself, comprising: (a) a plurality of walls defining a substantially enclosed interior; (b) a frame defining a cutout formed within one of the plurality of walls of the housing; and (c) a first door and a second door, the first and second doors form fitted over the cutout and hingedly secured to the frame, the first and second doors each comprising at least one panel having a front surface and a back surface.

The means for actuating, the elongated band, the at least one plate, and the at least one rod are located on the interior surface of the first door while the receptor is mounted on the interior surface of the second door.

The means for actuating, preferably, comprises a key actuated lock including a cylinder, the cylinder including a key receiving end and an opposed locking end. The cylinder extends through the first door of the housing and is accessible from both sides thereof. The lock further comprises a latch projecting radially and outwardly from the locking end of the cylinder and a lever rotatably interconnecting both the latch and the elongated band.

In use, as a user inserts a key into the key receiving end of the lock and turns the key, the cylinder rotates therewith. This action rotates the locking end of the lock and the latch, thereby lifting the lever upwardly or downwardly and, simultaneously, the elongated band in a corresponding direction.

As the elongated band translates, preferably in a vertical direction, the at least one plate rotatably connected thereto rotates in a corresponding direction and facilitates the horizontal translation of the at least one rod. The at least one rod then extends or retracts based on the movement of the elongated band in order to engage the receptor on the opposed door when the doors are in the closed position, thereby locking the doors in place.

For a more complete understanding of the present invention, reference is made to the following detailed description and accompanying drawing. In the drawing, like reference characters refer to like parts throughout the several views in which:

### BRIEF DESCRIPTION OF THE DRAWING

FIG. 1 is a rear view of a locking mechanism disposed on a storage safe with one panel in an open position;

FIG. 2 is a side view of the locking mechanism thereof with two panels in an open position;

FIG. 3 is an enlarged front view of the locking mechanism thereof as shown in circle A in FIG. 2; and

FIG. 4 is a front view of the locking mechanism in an alternative configuration.

### DETAILED DESCRIPTION OF THE INVENTION

As noted hereinabove and in a first aspect hereof, the locking mechanism of the present invention comprises: (a) an elongated band; (b) at least one plate rotatably connected to the elongated band; (c) at least one rod rotatably connected to the at least one plate; (d) means for actuating for actuating the locking mechanism; (e) a stabilizing member for maintaining the at least one rod in a substantially horizontal position; and (f) a receptor including at least one receptor opening formed therein.

In a second aspect hereof, the above locking mechanism 8 is deployed in conjunction with a storage safe or housing 10 for a display case 10′, such as those disclosed in disclosed and claimed in the aforementioned U.S. Pat. Nos. 9,078,531 and 9,512,663, the display case 10 being movable between a raised and a lowered position within the housing 10.

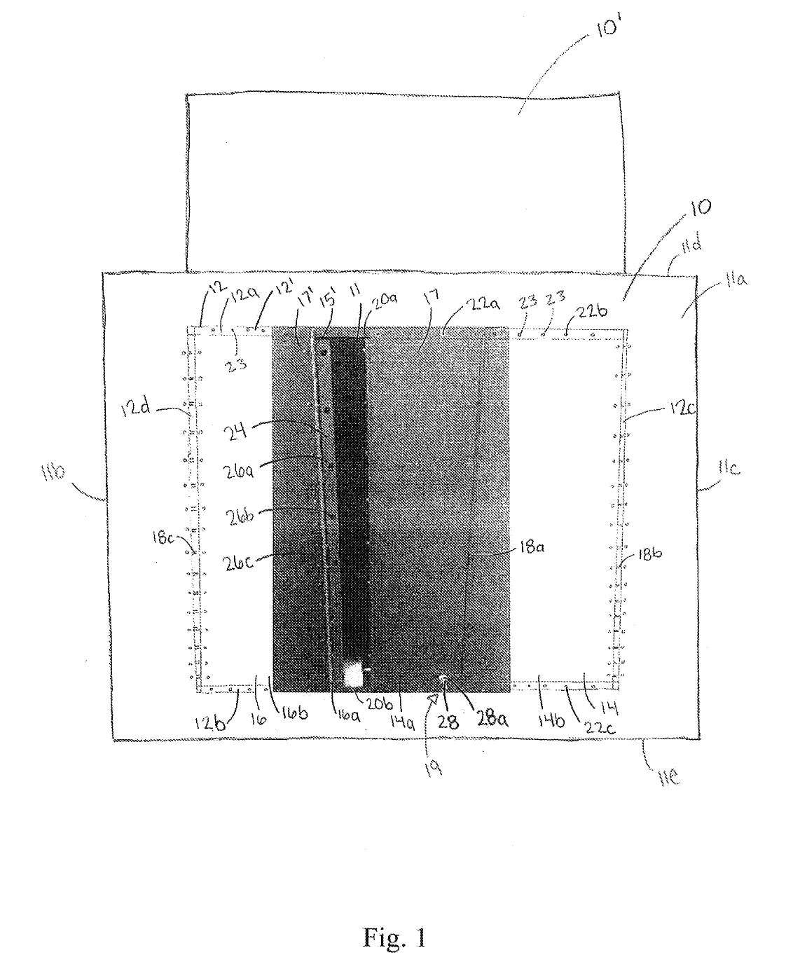

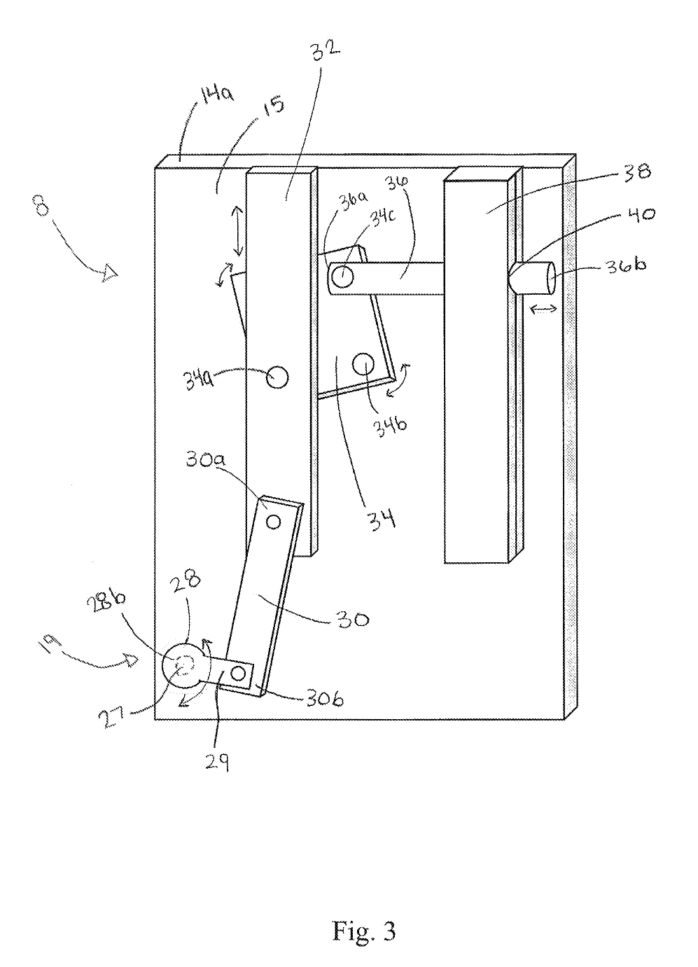

With more particularity and referring to FIGS. 1-3, the locking mechanism 8 is shown mounted to the housing 10. The housing 10 includes a substantially enclosed interior 11 defined by a plurality of walls 11a, 11b, 11c, 11d, 11e. The housing 10 further includes a frame 12′ which defines a cutout 12 formed in any of walls 11a, 11b, 11c. The frame 12′ includes a top edge 12a, a bottom edge 12b, and a pair of opposed side edges 12c, 12d. The cutout 12 provides access to the interior 11 of the housing 10 and to the display case 10′ when it is lowered into the housing 10.

A first door 14 and a second door 16, which are form fitted to the cutout 12, are hingedly mounted to the side edges 12c, 12d, respectively, of the frame 12′. Each door 14, 16, preferably, comprises at least one panel. Preferably, each door 14, 16 comprises a respective first panel 14a, 16a and a respective second panel 14b, 16b. Although, it is to be understood that each door 14, 16 may comprise any number of panels without deviating from the scope of the present invention.

Each panel 14a, 14b of the first door 16 includes an interior surface 15 and an exterior surface 17. Similarly, each panel 16a, 16b of the second door 16 includes an interior surface 15′ and an exterior surface 17′ as well. The first panels 14a, 16a are hingedly attached to an associated, adjacent second panel 14b, 16b of the same door via hinges 18a, 18b, 18c, etc. to provide a multi-paneled door. Alternatively, it is to be understood that each door 14, 16 may comprise a single panel without deviating from the scope of the present invention.

The locking mechanism 8 hereof, when employed with the present storage case or housing 10, enables the doors 14, 16 to be securely locked together when closed.

The locking mechanism 8 itself includes a vertically extending elongated band 32 coupled to the interior surface 15 of the first panel 14a of the first door 14. The elongated band 32 is a planar member which is translatable between an upper and a lower position, as detailed below. It is to be understood that the elongated band 32 may also be horizontally disposed and horizontally translatable without deviating from the scope of the present invention.

The locking mechanism 8 further comprises at least one plate 34 rotatably connected to the elongated band 32 and the first panel 14a of the first door 14. The at least one plate 34 includes a first pivot 34a, a second pivot 34b, and a third pivot 34c. Each pivot 34a, 34b, 34c comprises a fastener such as a rivet, a nut and bolt assembly, or the like which allows the plate 34 to rotate therearound and pivot accordingly. The first pivot 34a secures the plate 34 to the elongated band 32. The second pivot 34b secures the plate 34 to the interior surface 15 of the first panel 14a, thereby creating a fixed point of rotation for the plate 34 to rotate therearound. The third pivot 34c secures a rod 36 to the plate 34 and is located above the second pivot 34b for purposes described hereinbelow.

The locking mechanism 8 preferably comprises a plurality of equidistantly spaced apart and co-axial plates 34, 34′, 34″, etc. rotatably connected to the elongated band 32 in the same manner described above.

As noted above, the locking mechanism 8 further comprises at least one rod 36 having a first end 36a and an opposed second end 36b. The rod 36 is rotatably connected to the plate 34 via the third pivot 34c proximate the first end 36a of the rod 36. The rod 36 is maintained in a substantially horizontal position, perpendicular to the elongated band 32, as the second end 36b of the rod 36 is positioned within a stabilization member 38.

Where a plurality of plates 34, 34′, 34″, etc. is employed, it is understood that each one of the plurality of plates 34, 34′, 34″, etc. includes an associated rod 36 rotatably connected thereto.

In order to actuate the at least one rod 36 between extended and retracted positions, the locking mechanism 8 comprises means for actuating 19 for actuating the locking mechanism 8. The means for actuating 19 is operable between a locking position and an unlocking position in order to facilitate the vertical movement of the elongated band 32 and, thus, effectuate horizontal translation of the at least one rod 36, as described below.

The means for actuating 19 can be any suitable device such as a key actuated lock, a manual crank, an electric motor, the motor being AC or DC, or the like.

The means for actuating 19, preferably, comprises a key actuated lock 28 including a cylinder 27. The cylinder 27 includes a key receiving end 28a disposed on one end of the cylinder 27 and a locking end 28b disposed on the opposed end of the cylinder 27. The lock 28 further includes a latch 29 fixedly secured to the locking end 28b of the cylinder 27 and projecting radially and outwardly therefrom.

The means for actuating 19 further comprises a lever 30 rotatably interconnecting the lock 28 and the elongated band 32. The lever 30 includes a first end 30a and a second end 30b, the first end 30a of the lever 30 being rotatably connected to the latch 29. The lever 30 is further rotatably connected to the elongated band 32 proximate the second end 30b of the lever 30.

When installed within the housing 10, the lock 28 extends through the first door 14 such that the key receiving end 28a is accessible from the exterior surface 17 of the first door 14 and the locking end 28b is accessible from the interior surface 15 of the first door 14. The lock 28 is operated by a key in the manner described below.

As noted above, the locking mechanism 8 further comprises a stabilizing member 38 in order to maintain the rod 36 in a substantially horizontal position. While it is understood that the stabilizing member 38 can exhibit a variety of configurations, preferably, the stabilizing member 38 is an elongated member vertically disposed and secured to the interior surface 15 of the first panel 14a of the first door 14, or at least on the same panel as the rod 36. At least one stabilizing member opening 40 is formed within the stabilizing member 38 in the same axial plane as the rod 36. The stabilizing member 38 ensures substantially horizontal translation of the rod 36 and that the rod 36 aligns with the receptor opening 26a to prevent the doors 14, 16 from swinging open and, thereby, locking the doors 14, 16, to the housing 10 as described below. The second end 36b of the rod 36 is positioned within the stabilizing member opening 40 and at no point during operation does the rod 36 ever completely retract out of the stabilizing member opening 40.

Where a plurality of plates 34, 34′, 34″, etc. and a plurality of rods 36, 36′, 36″, etc. are employed, the stabilizing member 38 includes a plurality of stabilizing member openings 40, each stabilizing member opening 40 being in registry with an associated rod 36.

As shown in FIG. 1, a receptor 24 is fixedly, vertically mounted to the interior surface 15′ of the second door 16 opposite the stabilization member 38. The receptor 24 is an elongated element including at least one receptor opening 26a in registry and axially aligned with the at least one rod 36 and the stabilizing member opening 40. Preferably, the receptor 24 is disposed opposite side edge 12d of the frame 12′ such that the rod 36 can engage the receptor 24 when actuated. Thus, when the first door 14 and second door 16 are closed, the stabilizing member 38 and receptor 24 are, preferably, in close proximity with one another based on the length of the rod 36 to facilitate this engagement.

Where a plurality of rods 36, 36′, 36″, etc. is employed, the receptor 24 also includes a plurality of axially spaced apart receptor openings 26a, 26b, 26c, etc. each in registry with an associated rod 36 and an associated stabilizing member opening 40.

As the rods 36, 36′, 36″, etc. translate horizontally, the second end 36b of each rod 36 is received within an associated receptor opening 26a, 26b, 26c, etc. and retained therewithin until retracted.

In use, a user inserts a key (not shown) into the key receiving end 28a of the lock 28 and turns the key in a first direction into a locking position. As the key is turned, the cylinder 27 rotates the locking end 28b of the lock 28 and the latch 29 in a counterclockwise direction, thereby raising the lever 30 upwardly and, simultaneously, lifting the elongated band 32.

In this locking position, where a plurality of plates 34, 34′, 34″, etc. are utilized, the elongated band 32 is translated upwardly causing the plates 34, 34′, 34″, etc., which are rotatably connected thereto, to pivot about a respective second pivot 34b and rotate in a clockwise direction due to the second pivot 34b being lower than the third pivot 34c. As the plates 34, 34′, 34″, etc. pivot, the associated rods 36, 36′, 36″, etc. are translated horizontally. The rods 36, 36′, 36″, etc. each maintain a substantially horizontal orientation as a result of the rods 36, 36′, 36″, etc. being positioned within an associated stabilizing member opening 40.

As the rods 36, 36′, 36″, etc. extend toward the receptor 24, the second end 36b of each respective rod, 36′, 36″, etc. extends through an associated receptor opening 26b, 26c, etc., thereby locking the doors 14, 16 in place.

Conversely, the user unlocks the doors 14, 16 by inserting the key into the key receiving end 28a of the lock 28 and turning the key in a second, opposite direction, thereby into an unlocking position. As the key is turned in this direction, the cylinder 27 rotates the locking end 28b and the latch 29 in a clockwise direction, thereby pulling the lever 30 downwardly and, simultaneously, pulling the elongated band 32 downwardly as well.

In this unlocking position, the elongated band 32 translates downwardly causing each of the plates 34, 34′, 34″, etc. to pivot at a respective second pivot 34b and rotate in a counterclockwise direction. As the plates 34, 34′, 34″, etc. pivot, the associated rods 36, 36′, 36″, etc. maintain their horizontal position within the stabilizing member 38. As the rods 36, 36′, 36″, etc. retract, the second end 36b of each of the respective rods 36, 36′, 36″, etc. is drawn laterally out of an associated receptor opening 26a, thereby unlocking the doors 14, 16.

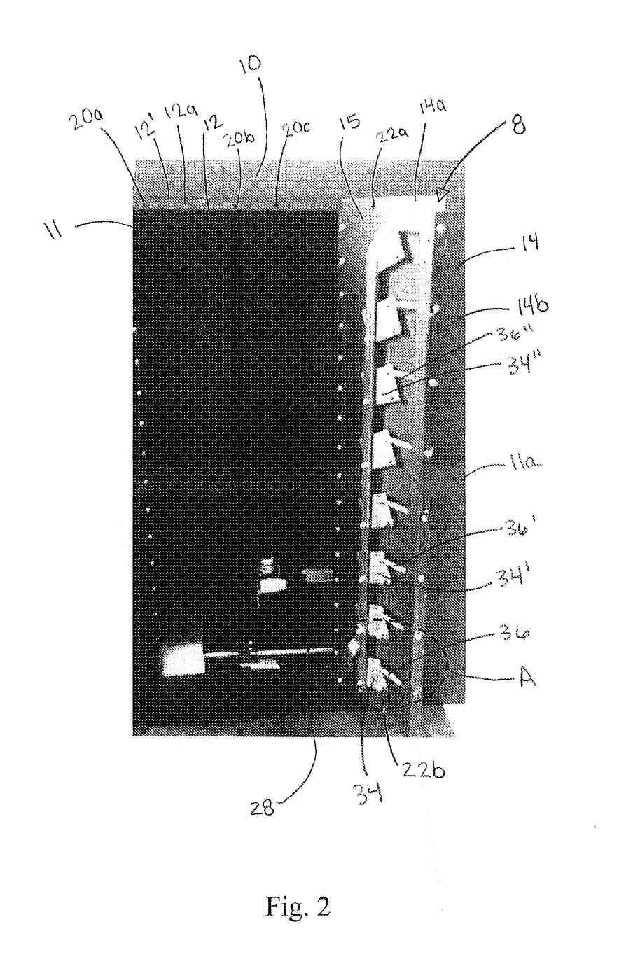

As seen in FIGS. 1 and 2, the top edge 12a and the bottom edge 12b of the frame 12 may further include a plurality of frame apertures 20a, 20b, 20c, etc. for further securing the doors 14, 16 to the housing 10. Here, the panels 14a, 14b, 16a, 16b include a plurality of panel apertures 22a, 22b, 22c, etc. in registry with a plurality of associated frame apertures 20a, 20b, 20c, etc. A plurality of fasteners 23, such as nuts and bolts, screws, or the like, project through the frame apertures 20a, 20b, 20c, etc. and the panel apertures 22a, 22b, 22c, etc. to secure the doors 14, 16 to the housing 10. The fasteners 23 are only accessible to the user once the locking mechanism 8 is unlocked and one of the first panels 14a, 16b swings open to allow access to the interior 11 of the housing 10.

When either first panel 14a or 16a is opened, the user is then able to reach into the interior 11 of the housing 10 and individually remove each of the fasteners 23. Once the fasteners 23 on the remaining, secured panels are removed, each panel may be opened as well to provide the user with full access to the interior of the housing 10 and the display case 10′ when lowered and stored therein.

When the user desires to close access to the interior 11 of the housing 10, the panels 14a, 14b, 16a, 16b are closed and the fasteners 23 are reattached to the frame apertures 20a, 20b, 20c, etc. and panel apertures 22a, 22b, 22c, etc. to secure the panels 14a, 14b, 16a, 16b to the housing 10. It should be understood that it is not necessary to provide frame apertures and panel apertures on both first panels 14a, 16a as any associated fasteners 23 would be impossible to access once both first panels 14a, 16a are closed. Therefore, only one of the first panels 14a, 16a need be secured in this manner.

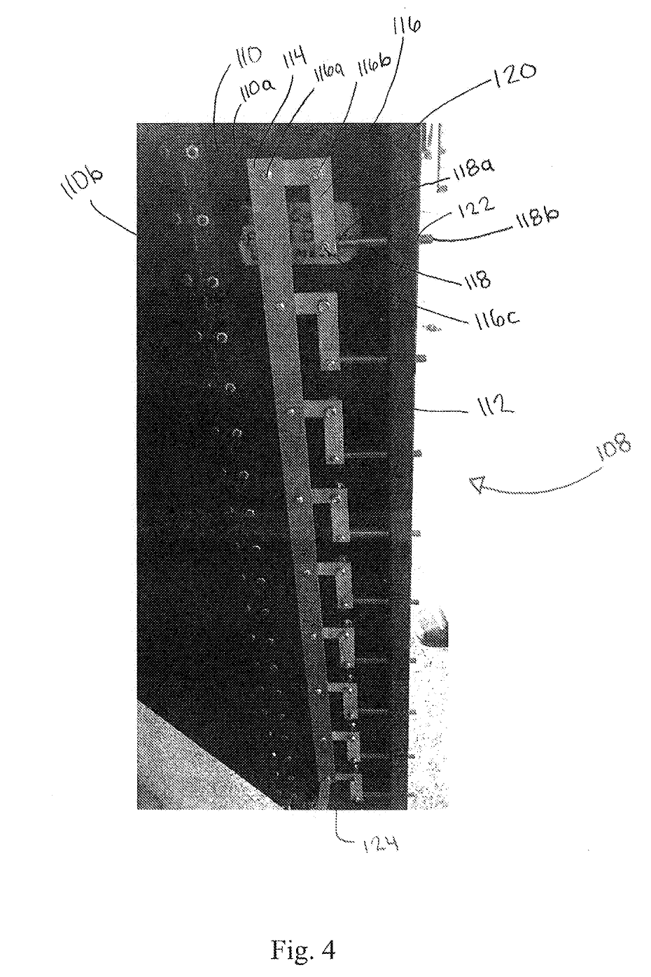

With reference to FIG. 4, in an alternative configuration, a locking mechanism 108 comprises an elongated band 114, at least one rod 118, a stabilizing member 120, and means for actuating 124. Each of these components is identical to like components in the locking mechanism 8 described above.

According to this alternative configuration, the locking mechanism further comprises at least one plate 116 having a first pivot 116a, a second pivot 116b, and a third pivot 116c located in a lower plane than the second pivot 116b. The at least one plate 116 forms a substantial right angle bracket. The plate 116 is rotatably attached to the elongated band 114 at the first pivot 116a, the second pivot 116b of the plate 116 is rotatably attached to an interior surface 112 of a first panel 110a of a first door 110 to create a fixed point of rotation. The rod 118 is rotatably attached at a first end 118a to the third pivot 116c of the plate 116.

Here, the plate 116 operates by pivoting about the second pivot 116b in an opposite direction than the plate 34 described above due to the second and third pivots 116b, 116c being in reversed locations respective one another, i.e. the second pivot 116b being higher than the third pivot 116c.

It is to be understood that there is no requirement that the components of the locking mechanism 8 be disposed on a specified door 14 or 16 as illustrated and described above. If the means for actuating 19, the elongated band 32, the at least one plate 34, the at least one rod 36, and the stabilizing member 38 are located on the second door 16 instead of the first door 14, the components on the second door 16, such as the receptor 24, would instead be located on the opposite first door 14. Here, the plate 34 would pivot in the opposite direction as the elongated band 32 translates vertically.

Having thus described the invention, what is claimed is:

1. A locking mechanism comprising:
(a) an elongated band;
(b) at least one plate rotatably connected to the elongated band;
(c) at least one rod rotatably connected to the at least one plate;
(d) means for actuating for actuating the locking mechanism, the means for actuating operable between a locking position and an unlocking position for translating the elongated band;
(e) a stabilizing member, the stabilizing member maintaining the at least one rod in a substantially horizontal position; and
(f) a receptor, the receptor including at least one receptor opening formed therein for receiving the rod.

2. The locking mechanism of claim 1 further comprising:
(a) a housing, the housing including:
(i) a plurality of walls defining a substantially enclosed interior;
(ii) a frame having a top edge, a bottom edge, and a pair of opposed side edges, the frame defining a cutout formed within one of the plurality of walls;
(iii) a first door and a second door form fitted over the cutout and hingedly secured to respective sidewalls of the frame, the first and second doors each comprising at least one panel having a front surface and a back surface;
wherein the at least one plate, the means for actuating, and the stabilizing member are disposed on the back surface of the at least one panel of the first door, the at least one plate rotatably connected to the at least one panel of the front door, the means for actuating being accessible from the front surface of the at least one panel of the front door; and
further wherein the receptor is disposed on the back surface of the at least one panel of the second door.

3. The locking mechanism of claim 2 wherein the at least one rod is in registry with at least one stabilizing member opening formed in the stabilizing member.

4. The locking mechanism of claim 2 further comprising a plurality of plates rotatably connected to the elongated band and to the at least one panel of the front door, the plurality of plates being axially and equidistantly spaced apart from one another along the elongated band.

5. The locking mechanism of claim 4 further comprising a plurality of rods, each one of plurality of rods rotatably connected to an associated one of the plurality of plates.

6. The locking mechanism of claim 4 wherein each one of the plurality of rods are in registry with an associated one of a plurality of stabilizing member openings formed within the stabilizing member.

7. The locking mechanism of claim 4 further comprising a plurality receptor openings formed within the receptor, each one of the plurality of receptor openings in registry with an associated one of the plurality of rods.

8. The locking mechanism of claim 1 wherein the means for actuating is a key actuated lock, the lock comprising:
(a) a cylinder including a key receiving end and an opposed locking end;
(b) a latch having a first end and a second end, the first end of the latch being secured to the locking end of the cylinder and projecting radially and outwardly therefrom;
(c) a lever having a first end and a second end, the first end of the lever being rotatably connected to the second end of the latch and extending upwardly therefrom, the second end of the lever being rotatably connected to the elongated band; and
wherein operating the means for actuating between an unlocking position and a locking position translates the elongated band in respective directions.

9. The locking mechanism of claim 1 wherein the at least one plate forms a substantially right angle bracket rotatably connected to the elongated band.

10. The locking mechanism of claim 2 wherein the first and second doors of the housing are secured to the housing by a plurality of fasteners insertable into a plurality of respective frame apertures formed within the top wall and the bottom wall of the frame and a plurality of respective panel apertures formed in each of the at least one panels of the first and second doors, each one of the plurality of frame apertures being in registry with an associated one of the plurality of panel apertures.

11. A storage case comprising:
(a) a housing including:
(i) a plurality of walls defining a substantially enclosed interior;
(ii) a frame having a top edge, a bottom edge, and a pair of opposed side edges, the frame defining a cutout formed within one of the plurality of walls;
(iii) a first door and a second door form fitted over the cutout and hingedly secured to respective sidewalls of the frame, the first and second doors each comprising at least one panel having a front surface and a back surface;
(b) a locking mechanism including:
(i) an elongated band;
(ii) at least one plate rotatably connected to the elongated band;
(iii) at least one rod rotatably connected to the at least one plate;
(iv) means for actuating for actuating the locking mechanism, the means for actuating operable between a locking position and an unlocking position for translating the elongated band;
(v) a stabilizing member, the stabilizing member maintaining the at least one rod in a substantially horizontal position;
(vi) a receptor, the receptor including at least one receptor opening formed therein for receiving the rod;
wherein the at least one plate, the means for actuating, and the stabilizing member are disposed on the back surface of the at least one panel of the first door, the at least one plate rotatably connected to the at least one panel of the front door, the means for actuating being accessible from the front surface of the at least one panel of the front door; and
further wherein the receptor is disposed on the back surface of the at least one panel of the second door.

12. A storage case comprising:
(a) a housing including:
(i) a plurality of walls defining a substantially enclosed interior;
(ii) a display case movable between a raised and a lowered position within the interior thereof;
(iii) a frame having a top edge, a bottom edge, and a pair of opposed side edges, the frame defining a cutout formed within one of the plurality of walls;
(iv) a first door and a second door form fitted over the cutout and hingedly secured to respective sidewalls of the frame, the first and second doors each comprising at least one panel having a front surface and a back surface;
(b) a locking mechanism including:
(i) an elongated band;
(ii) at least one plate rotatably connected to the elongated band;
(iii) at least one rod rotatably connected to the at least one plate;
(iv) means for actuating for actuating the locking mechanism, the means for actuating operable between a locking position and an unlocking position for translating the elongated band;
(v) a stabilizing member, the stabilizing member maintaining the at least one rod in a substantially horizontal position;
(vi) a receptor, the receptor including at least one receptor opening formed therein for receiving the rod;
wherein the at least one plate, the means for actuating, and the stabilizing member are disposed on the back surface of the at least one panel of the first door, the at least one plate rotatably connected to the at least one panel of the front door, the means for actuating being accessible from the front surface of the at least one panel of the front door; and
further wherein the receptor is disposed on the back surface of the at least one panel of the second door.
